(19) United States
(12) Patent Application Publication
(10) Pub. No.: US 2006/0169477 A1
(43) Pub. Date: Aug. 3, 2006

(54) Cable insulation system with flexibility, high temperature deformation resistance, and reduced degree of stickiness

(76) Inventor: Laurence H. Gross, Bridgewater, NJ (US)

Correspondence Address: UNION CARBIDE CHEMICALS AND PLASTICS TECHNOLOGY;CORPORATION, P.O. BOX 1967, MIDLAND, MI, 48674, US

(21) Appl. No.: 10/564,142

(22) PCT Filed: Jul. 22, 2004
(86) PCT No.: PCT/US04/23723

§ 371 Date: Jan. 10, 2006

(30) Foreign Application Priority Data
Jul. 24, 2003 (US) 60490314

(51) Int. Cl. H01B 3/44

(52) U.S. Cl. 174/110 R

(57) ABSTRACT

The present invention is a cable comprising one or more electrical conductors or a core of one or more electrical conductors and having each conductor or core being surrounded by a layer of insulation. The insulation comprises an olefinic polymer, having a density in the range of 0.880 to 0.915 grams per cubic centimeter, a melting temperature of at least 115 degrees Celsius, a melt index in the range of 0.5 to 10 grams per 10 minutes, a crystallization-analysis-soluble fraction in 1,2,4-trichlorobenzene at 30 degrees Celsius of less than 35 weight percent, and a polydispersity index of at least 3.5. Alternatively, the insulation layer has an 1% secant flexural modulus at ambient of less than 15,000 psi and a dynamic elastic modulus at 150 degrees Celsius of at least 4×10⁷ dyne/square centimeter.

This invention relates to a power cable insulation layer. Specifically, the insulation layer is useful for low to high voltage wire-and-cable applications.

Flexibility of an electric power cable, and especially of the insulation layer (as it is the thickest polymeric layer), is an important feature for handling cables during installation in the relatively tight quarters of manholes and for terminations and joints. Another important feature of the insulation layer is high temperature deformation resistance (that is, high melting point above 115 degrees Celsius). However, achieving flexibility and high temperature deformation resistance has proven difficult because polymeric composition candidates have proven to be blocky or deposit a film or residue on the processing equipment during processing. Incorporating peroxides into conventional polymeric compositions further exacerbates the problems of blockiness and deposits.

There is a need for power cable insulation layer having excellent flexibility and excellent high temperature deformation resistance and which is prepared from a polymeric composition that does not block during storage and processing and that does not deposit a film or residue on processing equipment.

### DESCRIPTION OF THE INVENTION

The present invention is a cable comprising one or more electrical conductors or a core of one or more electrical conductors and having each conductor or core being surrounded by a layer of insulation. The insulation layer comprises an olefinic polymer, having a density in the range of 0.880 to 0.915 grams per cubic centimeter, a melting temperature of at least 115 degrees Celsius, a melt index in the range of 0.5 to 10 grams per 10 minutes, a crystallization-analysis-soluble fraction in 1,2,4-trichlorobenzene at 30 degrees Celsius of less than 35 weight percent, and a polydispersity index of at least 3.5. Alternatively, the insulation layer has an 1% secant flexural modulus at ambient of less than 15,000 psi and a dynamic elastic modulus at 150 degrees Celsius of at least 4×10⁷ dyne/square centimeter.

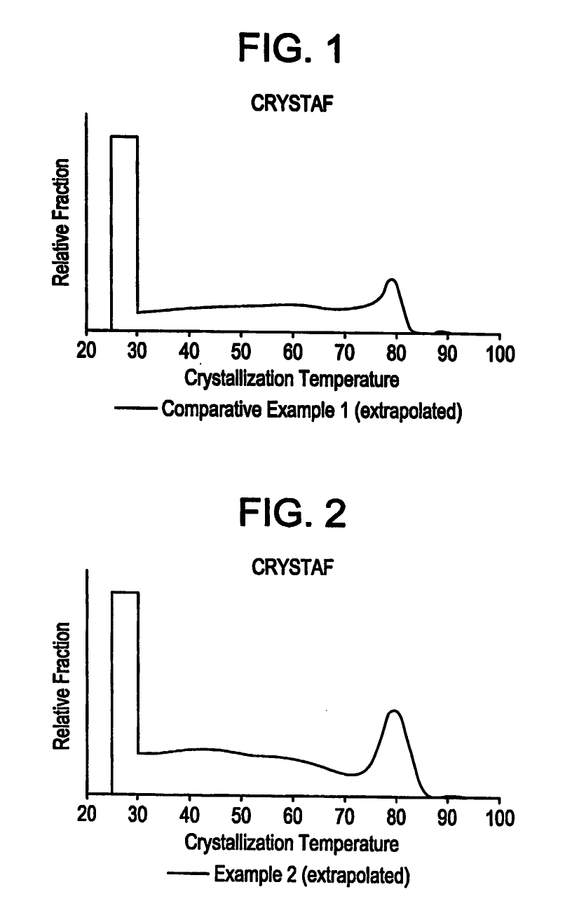

FIG. 1 shows the CRYSTAF crystallization kinetic curve for Comparative Example 1.

FIG. 2 shows the CRYSTAF crystallization kinetic curve for Example 2.

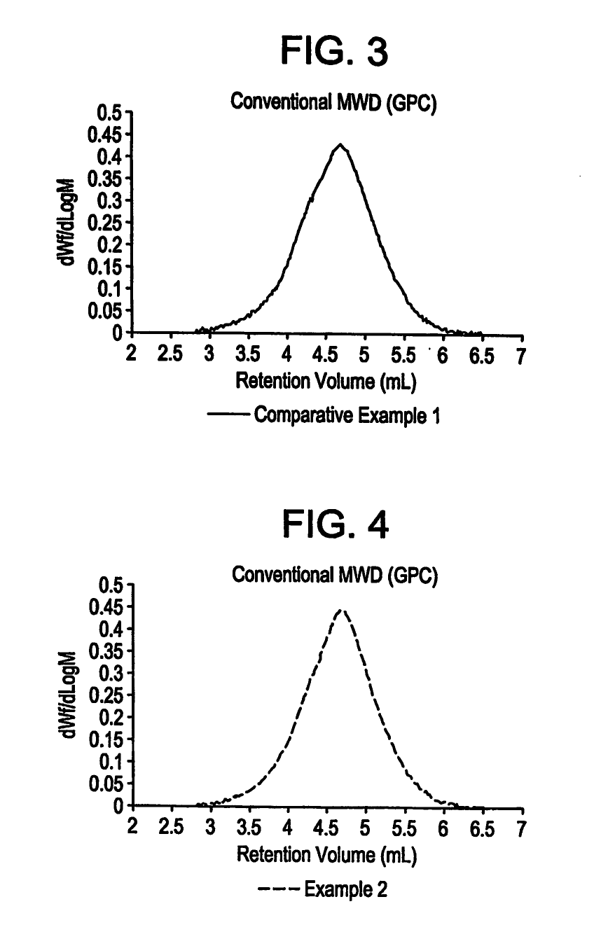

FIG. 3 shows the molecular weight distribution curve for Comparative Example 1.

FIG. 4 shows the molecular weight distribution curve for Example 2.

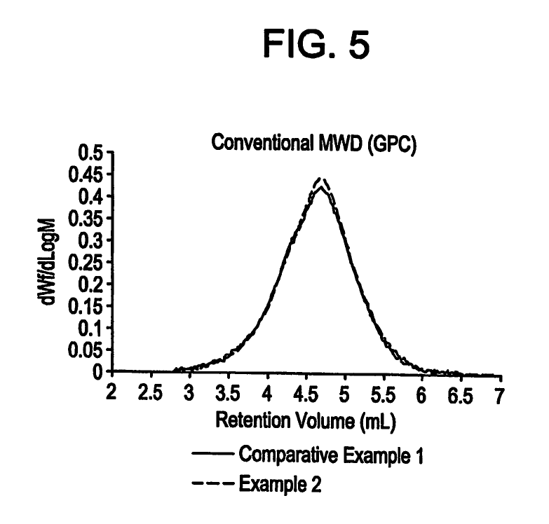

FIG. 5 shows an overlay of the molecular weight distribution curves for Comparative Example 1 and Example 2.

The invented cable comprises one or more electrical conductors or a core of one or more electrical conductors, each conductor or core being surrounded by a layer of insulation comprising an olefinic polymer, having a density in the range of 0.880 to 0.915 grams per cubic centimeter, a melting temperature of at least 115 degrees Celsius, a melt index in the range of 0.5 to 10 grams per 10 minutes, a crystallization-analysis-soluble fraction in 1,2,4-trichlorobenzene at 30 degrees Celsius of less than 35 weight percent, and a polydispersity index of at least 3.5. Preferably, the olefinic polymer is a polyethylene polymer.

Polyethylene polymer, as that term is used herein, is a copolymer of ethylene and a minor proportion of one or more alpha-olefins having 3 to 12 carbon atoms, and preferably 3 to 8 carbon atoms, and, optionally, a diene, or a mixture or blend of such copolymers. Specifically useful polyethylenes include very low density polyethylenes (VLDPEs) and ultra low density polyethylenes (ULDPEs).

The portion of the polyethylene polymer attributed to the comonomer(s), other than ethylene, can be in the range of 1 to 49 percent by weight based on the weight of the copolymer and is preferably in the range of 15 to 40 percent by weight. Examples of the alpha-olefins are propylene, 1-butene, 1-hexene, 4-methyl-1-pentene, and 1-octene. Suitable examples of dienes include ethylidene norbornene, butadiene, 1,4-hexadiene, or a dicyclopentadiene. The mixture can be a mechanical blend or an in situ blend, and can include homopolymers of ethylene.

The polyethylene polymer can have a density in the range of 0.880 to 0.915 grams per cubic centimeter, and preferably have a density in the range of 0.895 to 0.910 grams per cubic centimeter. More preferably, the polyethylene polymer has a density in the range of 0.900 to 0.905 grams per cubic centimeter.

The polyethylene polymer also can have a melt index in the range of 0.5 to 10 grams per 10 minutes. Preferably, the melt index is in the range of 1 to 5 grams per 10 minutes. Melt index is determined under ASTM D-1238, Condition E and measured at 190 degree C. and 2160 grams.

The polyethylene polymer also can have a melting temperature of at least 115 degrees Celsius. Preferably, the melting temperature is greater than 115 degrees Celsius. More preferably, the melting temperature is greater than 120 degrees Celsius.

The polyethylene polymer also can have a crystallization-analysis-soluble fraction of less than 35 weight percent. Preferably, the crystallization-analysis-soluble fraction is less than 32 weight percent.

The polyethylene can be heterogeneous. The heterogeneous polyethylene polymers usually have a polydispersity index (Mw/Mn) of at least 3.5 and lack a uniform comonomer distribution. Mw is defined as weight average molecular weight, and Mn is defined as number average molecular weight. Preferably, the polydispersity index is greater than 4.0.

Low-pressure processes can produce the polyethylene polymer. The polyethylene polymer can be produced in gas phase processes or in liquid phase processes (that is, solution processes) by conventional techniques. Low-pressure processes are typically run at pressures below 1000 pounds per square inch (“psi”).

Typical catalyst systems for preparing the polyethylene polymer include magnesium/titanium-based catalyst systems, vanadium-based catalyst systems, chromium-based catalyst systems, and other transition metal catalyst systems. Many of these catalyst systems are often referred to as Ziegler-Natta catalyst systems or Phillips catalyst systems. The preferable catalyst system is a Ziegler-Natta catalyst system. Useful catalyst systems include catalysts using chromium or molybdenum oxides on silica-alumina supports.

Useful catalyst systems may comprise combinations of various catalyst systems (for example, Ziegler-Natta catalyst system with a metallocene catalyst system). These combined catalyst systems are most useful in multi-stage reactive processes.

The insulation layer may be crosslinkable or thermoplastic. Crosslinking agents include peroxides. The polyethylene polymer may be rendered moisture-crosslinkable by grafting the polyethylene with a vinylsilane in the presence of a free radical initiator. When the silane-functionalized polyethylene is used, the composition for making the insulation layer may further comprise a crosslinking catalyst in the formulation (such as dibutyltindilaurate or dodecylbenzenesulfonic acid) or another Lewis or Bronsted acid or base catalyst. Vinyl alkoxysilanes (for example, vinyltrimethoxysilane and vinyltriethoxysilane) are suitable silane compounds for grafting.

In addition, the polymeric material for preparing the insulation layer may contain additives such as catalysts, stabilizers, scorch retarders, water-tree retarders, electrical-tree retarders, colorants, corrosion inhibitors, lubricants, anti-blocking agents, flame retardants, and processing aids.

In a preferred embodiment, the present invention is a cable comprising one or more electrical conductors or a core of one or more electrical conductors, each conductor or core being surrounded by a layer of insulation comprising a polyethylene, having a density in the range of 0.900 to 0.905 grams per cubic centimeter, a melting temperature of greater than 120 degrees Celsius, a melt index in the range of 1 to 5 grams per 10 minutes, a crystallization-analysis-soluble fraction less than 35 weight percent, and a polydispersity index of greater than 4.0.

In an alternate embodiment, the present invention is a cable comprising one or more electrical conductors or a core of one or more electrical conductors, each conductor or core being surrounded by a layer of insulation, having a 1% secant flexural modulus at ambient of less than 15,000 psi and a dynamic elastic modulus at 150 degrees Celsius of at least 4×10⁷ dyne/square centimeter. Preferably, the 1% secant flexural modulus at ambient is less than 10,000 psi, the dynamic elastic modulus at 150 degrees Celsius is at least 5×10⁷ dyne/square centimeters, or both.

### EXAMPLES

The following non-limiting examples illustrate the invention.

### Crystallization-Analysis Soluble Fraction

The crystallization-analysis soluble fraction was determined for two potential base resins. The base resins were selected because of their density, melt index, and potential for crosslinking with peroxide.

Comparative Example 1 was a VLDPE, prepared by a gas-phase process and commercially available from The Dow Chemical Company as Flexomer™ DFDA-8845. It had a density of 0.902 grams/cubic-centimeter and a melt index of 4 grams/10 minutes. Example 2 was a VLDE, prepared by a solution process and commercially available from The Dow Chemical Company as Attane™ 4404G. It had a density of 0.904 grams/cubic centimeter and a melt index of 4 grams/10 minutes.

The crystallization-analysis soluble fraction was determined using a CRYSTAF instrument available from PolymerChar of Valencia, Spain, which generated a CRYSTAF crystallization kinetic curve. The polymer sample was dissolved at 150 degrees Celsius in 1,2,4-trichlorobenzene and then placed into a reactor. The solution was allowed to equilibrate at 95-100 degrees Celsius. The solution was then cooled at the rate of 2 degrees Celsius per minute. As the temperature was lowered, crystals were formed. Each sample was filtered before it was removed from the reactor. The portion, which passed through the filter, was analyzed using an infrared detector to determine its concentration. The concentration of polymer remaining in the reactor was determined by difference.

FIG. 1 shows the CRYSTAF crystallization kinetic curve for Comparative Example 1 while FIG. 2 shows the CRYSTAF crystallization kinetic curve for Example 2. Comparative Example 1 presented a crystallization-analysis soluble fraction in 1,2,4-trichlorobenzene at 30 degrees Celsius of 40.5 weight percent. Example 2 presented a crystallization-analysis soluble fraction in 1,2,4-trichlorobenzene at 30 degrees Celsius of 31.8 weight percent.

### Molecular Weight Distribution

The molecular weight distribution of the two potential base resins was also determined via gel permeation chromatography. FIG. 3 shows the molecular weight distribution for Comparative Example 1. FIG. 4 shows the molecular weight distribution for Example 2. FIG. 5 shows an overlay of the molecular weight distribution curves for Comparative Example 1 and Example 2.

The chromatographic system consisted of a Waters 150C high temperature chromatograph. Data collection was performed using Viscotek TriSEC software version 3 and a 4-channel Viscotek Data Manager DM400.

The carousel compartment was operated at 140 degrees Celsius and the column compartment was operated at 150 degrees Celsius. The columns used were 7 Polymer Laboratories 20-micron Mixed-A LS columns. The solvent used was 1,2,4-trichlorobenzene. The samples were prepared at a concentration of 0.1 grams of polymer in 50 milliliters of solvent with gentle agitation at 160 degrees Celsius for 4 hours. The solvent used to prepare the samples contained 200 ppm of butylated hydroxytoluene (BHT). The injection volume used was 200 microliters, and the flow rate was 1.0 milliliters/minute.

Calibration of the GPC column set was performed with narrow molecular weight distribution polystyrene standards purchased from Polymer Laboratories. The refractometer was calibrated for mass verification purposes based on the known concentration and injection volume.

### Blockiness

The blockiness of the two potential base resins was determined. Comparative Examples 3 was a peroxide-containing sample of the Comparative Example 1 resin. Example 4 was a peroxide-containing sample of the Example 2 resin.

The blockiness was determined by holding 200 grams of the evaluated material at 70 degrees Celsius for 7 hours under 6 pounds in a container having a square base (3.75 inches×3.75 inches) and then holding the material at ambient temperature for an additional 16 hours. Finally, the bottom of the container was opened and the amount of force necessary to push the material through the bottom of the container was measured. The results are reported in Table 1.

TABLE 1

| | Comp. | Comp. | Example | Example |
|---|---|---|---|---|
| | Ex. 1 | Ex. 3 | 2 | 4 |
| Peroxide Added | No | Yes | No | Yes |
| Force Required (pounds) | 16 | 12.5 | 0 | 4 |

### Pellet Impact Test—Conveying Polymeric Material

The amount residue deposited from the two potential base resins was determined using a 2-cubic foot supply hopper connected to 1½-inch Fox eductor valve, which in turn was connected by 12 feet of 1½-inch stainless steel tubing to a ½-cubic foot collection hopper. The collection hopper had an adjustable plate holder, and the impact test plate could be set at various angles. The collection hopper was arranged such that it discharged the conveyed resin into a 55-gallon drum under atmospheric pressure. As the drum filled, the resin was recirculated through the equipment.

The resin velocities were controlled by the Fox valve motive air supply, which was set at 20 psi. Air exited the tubing at a rate of 66 feet/second.

A fluid bed was used to supply the heated resin to the test unit for evaluation. The resins were tested at 45 degrees Celsius and 60 degrees Celsius for two-hour intervals.

The Example 2 material produced a lesser amount of residue in the test unit than the Comparative Example 1 material.

What is claimed is:

1. A cable comprising one or more electrical conductors or a core of one or more electrical conductors, each conductor or core being surrounded by a layer of insulation comprising an olefinic polymer, having a density in the range of 0.880 to 0.915 grams per cubic centimeter, a melting temperature of at least 115 degrees Celsius, a melt index in the range of 0.5 to 10 grams per 10 minutes, a crystallization-analysis-soluble fraction less than 35 weight percent, and a polydispersity index of at least 3.5.

2. The cable of claim 1 wherein the olefinic polymer being a polyethylene.

3. The cable of claim 1 wherein the olefinic polymer having a density in the range of 0.895 to 0.910 grams per cubic centimeter.

4. The cable of claim 1 wherein the olefinic polymer having a density in the range of 0.900 to 0.905 grams per cubic centimeter.

5. The cable of claim 1 wherein the olefinic polymer having a melting temperature greater than 115 degrees Celsius.

6. The cable of claim 1 wherein the olefinic polymer having a melting temperature greater than 120 degrees Celsius.

7. The cable of claim 1 wherein the olefinic polymer having a melt index in the range of 1 to 5 grams per 10 minutes.

8. The cable of claim 1 wherein the olefinic polymer having a crystallization-analysis-soluble fraction less than 32 weight percent.

9. The cable of claim 1 wherein the olefinic polymer having polydispersity index of greater than 4.0.

10. The cable of claim 1 wherein the olefinic polymer having a heterogeneous comonomer distribution.

11. The cable of claim 1 wherein the olefinic polymer being prepared using a Ziegler-Natta catalyst.

12. The cable of claim 1 wherein the layer of insulation being crosslinkable.

13. The cable of claim 1 wherein the layer of insulation being thermoplastic.

14. A cable comprising one or more electrical conductors or a core of one or more electrical conductors, each conductor or core being surrounded by a layer of insulation comprising a polyethylene, having a density in the range of 0.900 to 0.905 grams per cubic centimeter, a melting temperature of greater than 120 degrees Celsius, a melt index in the range of 1 to 5 grams per 10 minutes, a crystallization-analysis-soluble fraction less than 35 weight percent, and a polydispersity index of greater than 4.0.

15. A cable comprising one or more electrical conductors or a core of one or more electrical conductors, each conductor or core being surrounded by a layer of insulation, having 1% secant flexural modulus at ambient of less than 15,000 psi and a dynamic elastic modulus at 150 degrees Celsius of at least 4×10⁷ dyne/square centimeter.

16. The cable of claim 15 wherein the layer of insulation, having 1% secant flexural modulus at ambient of less than 10,000 psi.

17. The cable of claim 15 wherein the layer of insulation, having a dynamic elastic modulus at 150 degrees Celsius of at least 5×10⁷ dyne/square centimeter.

18. The cable of claim 15 wherein the layer of insulation, having 1% secant flexural modulus at ambient of less than 10,000 psi and a dynamic elastic modulus at 150 degrees Celsius of at least 5×10⁷ dyne/square centimeter.
